(19) United States
(12) Patent Application Publication
(10) Pub. No.: US 2007/0160219 A1
(43) Pub. Date: Jul. 12, 2007

(54) Decoding of binaural audio signals

(75) Inventors: Julia Jakka, Espoo (FI); Pasi Ojala, Kirkkonummi (FI); Mauri Vaananen, Tampere (FI); Mikko Tammi, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/354,211

(22) Filed: Feb. 13, 2006

(30) Foreign Application Priority Data
Jan. 9, 2006 (FI) PCT/FI06/50014

(51) Int. Cl. H04R 5/00; H04R 5/02

(52) U.S. Cl. 381/22; 381/309

(57) ABSTRACT

A method for synthesizing a binaural audio signal, the method comprising: inputting a parametrically encoded audio signal comprising at least one combined signal of a plurality of audio channels and one or more corresponding sets of side information describing a multi-channel sound image; and applying a predetermined set of head-related transfer function filters to the at least one combined signal in proportion determined by said corresponding set of side information to synthesize a binaural audio signal.

### RELATED APPLICATIONS

This application claims priority from an international application PCT/FI2006/050014, filed on Jan. 9, 2006.

### FIELD OF THE INVENTION

The present invention relates to spatial audio coding, and more particularly to decoding of binaural audio signals.

### BACKGROUND OF THE INVENTION

In spatial audio coding, a two/multi-channel audio signal is processed such that the audio signals to be reproduced on different audio channels differ from one another, thereby providing the listeners with an impression of a spatial effect around the audio source. The spatial effect can be created by recording the audio directly into suitable formats for multi-channel or binaural reproduction, or the spatial effect can be created artificially in any two/multi-channel audio signal, which is known as spatialization.

It is generally known that for headphones reproduction artificial spatialization can be performed by HRTF (Head Related Transfer Function) filtering, which produces binaural signals for the listener's left and right ear. Sound source signals are filtered with filters derived from the HRTFs corresponding to their direction of origin. A HRTF is the transfer function measured from a sound source in free field to the ear of a human or an artificial head, divided by the transfer function to a microphone replacing the head and placed in the middle of the head. Artificial room effect (e.g. early reflections and/or late reverberation) can be added to the spatialized signals to improve source externalization and naturalness.

As the variety of audio listening and interaction devices increases, compatibility becomes more important. Amongst spatial audio formats the compatibility is striven for through upmix and downmix techniques. It is generally known that there are algorithms for converting multi-channel audio signal into stereo format, such as Dolby Digital® and Dolby Surround®, and for further converting stereo signal into binaural signal. However, in this kind of processing the spatial image of the original multi-channel audio signal cannot be fully reproduced. A better way of converting multi-channel audio signal for headphone listening is to replace the original loudspeakers with virtual loudspeakers by employing HRTF filtering and to play the loudspeaker channel signals through those (e.g. Dolby Headphone®). However, this process has the disadvantage that, for generating a binaural signal, a multi-channel mix is always first needed. That is, the multi-channel (e.g. 5+1 channels) signals are first decoded and synthesized, and HRTFs are then applied to each signal for forming a binaural signal. This is computationally a heavy approach compared to decoding directly from the compressed multi-channel format into binaural format.

Binaural Cue Coding (BCC) is a highly developed parametric spatial audio coding method. BCC represents a spatial multi-channel signal as a single (or several) downmixed audio channel and a set of perceptually relevant inter-channel differences estimated as a function of frequency and time from the original signal. The method allows for a spatial audio signal mixed for an arbitrary loudspeaker layout to be converted for any other loudspeaker layout, consisting of either same or different number of loudspeakers.

Accordingly, the BCC is designed for multi-channel loudspeaker systems. However, generating a binaural signal from a BCC processed mono signal and its side information requires that a multi-channel representation is first synthesised on the basis of the mono signal and the side information, and only then it may be possible to generate a binaural signal for spatial headphones playback from the multi-channel representation. It is apparent that neither this approach is optimized in view of generating a binaural signal.

### SUMMARY OF THE INVENTION

Now there is invented an improved method and technical equipment implementing the method, by which generating a binaural signal is enabled directly from a parametrically encoded audio signal. Various aspects of the invention include a decoding method, a decoder, an apparatus, an encoding method, an encoder, and computer programs, which are characterized by what is generally disclosed in detail below. Various embodiments of the invention are disclosed as well.

According to a first aspect, a method according to the invention is based on the idea of synthesizing a binaural audio signal such that a parametrically encoded audio signal comprising at least one combined signal of a plurality of audio channels and one or more corresponding sets of side information describing a multi-channel sound image is first inputted. Then a predetermined set of head-related transfer function filters are applied to the at least one combined signal in proportion determined by said corresponding set of side information to synthesize a binaural audio signal.

According to an embodiment, from the predetermined set of head-related transfer function filters, a left-right pair of head-related transfer function filters corresponding to each loudspeaker direction of the original multi-channel loudspeaker layout is chosen to be applied.

According to an embodiment, said set of side information comprises a set of gain estimates for the channel signals of the multi-channel audio, describing the original sound image.

According to an embodiment, the gain estimates of the original multi-channel audio are determined as a function of time and frequency; and the gains for each loudspeaker channel are adjusted such the sum of the squares of each gain value equals to one.

According to an embodiment, the at least one combined signal is divided into time frames of an employed frame length, which frames are then windowed; and the at least one combined signal is transformed into frequency domain prior to applying the head-related transfer function filters.

According to an embodiment, the at least one combined signal is divided in frequency domain into a plurality of psycho-acoustically motivated frequency bands, such as frequency bands complying with the Equivalent Rectangular Bandwidth (ERB) scale, prior to applying the head-related transfer function filters.

According to an embodiment, outputs of the head-related transfer function filters for each of said frequency band for a left-side signal and a right-side signal are summed up separately; and the summed left-side signal and the summed right-side signal are transformed into time domain to create a left-side component and a right-side component of a binaural audio signal.

According to an alternative embodiment, instead of using the set of gain estimates and applying them to each frequency subband, the at least one combined signal is divided into a plurality of frequency bins in frequency domain; and gain values are determined for each frequency bin from said set of side information prior to applying the head-related transfer function filters.

According to an embodiment, said gain values are determined by interpolating each gain value corresponding to a particular frequency bin from next and previous gain values provided by said set of side information or by selecting the closest gain value provided by said set of side information.

According to an embodiment, the step of determining gain values for each frequency bin further comprises: determining gain values for each channel signal of the multi-channel audio describing the original sound image; and interpolating a single gain value for each frequency bin from said gain values of each channel signal.

According to an embodiment, a frequency domain representation of the binaural signal is determined for each frequency bin by multiplying said at least one combined signal with said single gain value and a predetermined head-related transfer function filter.

A second aspect provides a method for generating a parametrically encoded audio signal, the method comprising: inputting a multi-channel audio signal comprising a plurality of audio channels; generating at least one combined signal of the plurality of audio channels; and generating one or more corresponding sets of side information including gain estimates for the plurality of audio channels.

According to an embodiment, the gain estimates are calculated by comparing the gain level of each individual channel to the cumulated gain level of the combined signal.

The arrangement according to the invention provides significant advantages. A major advantage is the simplicity and low computational complexity of the decoding process. The decoder is also flexible in the sense that it performs the binaural synthesis completely on basis of the spatial and encoding parameters given by the encoder. Furthermore, equal spatiality regarding the original signal is maintained in the conversion. As for the side information, a set of gain estimates of the original mix suffice. Most significantly, the invention enables enhanced exploitation of the compressive intermediate state provided in the parametric audio coding, improving efficiency in transmitting as well as in storing the audio. The alternative embodiment described above, wherein the gain values are determined for each frequency bin from the side information, provides the advantage that the quality of the binaural output signal can be improved by introducing smoother changes of the gain values from one frequency band to another.

The further aspects of the invention include various apparatuses arranged to carry out the inventive steps of the above methods.

### BRIEF DESCRIPTION OF THE DRAWINGS

In the following, various embodiments of the invention will be described in more detail with reference to the appended drawings, in which

FIG. 1 shows a generic Binaural Cue Coding (BCC) scheme according to prior art;

FIG. 2 shows the general structure of a BCC synthesis scheme according to prior art;

FIG. 3 shows a block diagram of the binaural decoder according to an embodiment of the invention; and

FIG. 4 shows an electronic device according to an embodiment of the invention in a reduced block chart.

### DETAILED DESCRIPTION OF EMBODIMENTS OF THE INVENTION

In the following, the invention will be illustrated by referring to Binaural Cue Coding (BCC) as an exemplified platform for implementing the decoding scheme according to the embodiments. It is, however, noted that the invention is not limited to BCC-type spatial audio coding methods solely, but it can be implemented in any audio coding scheme providing at least one audio signal combined from the original set of one or more audio channels and appropriate spatial side information.

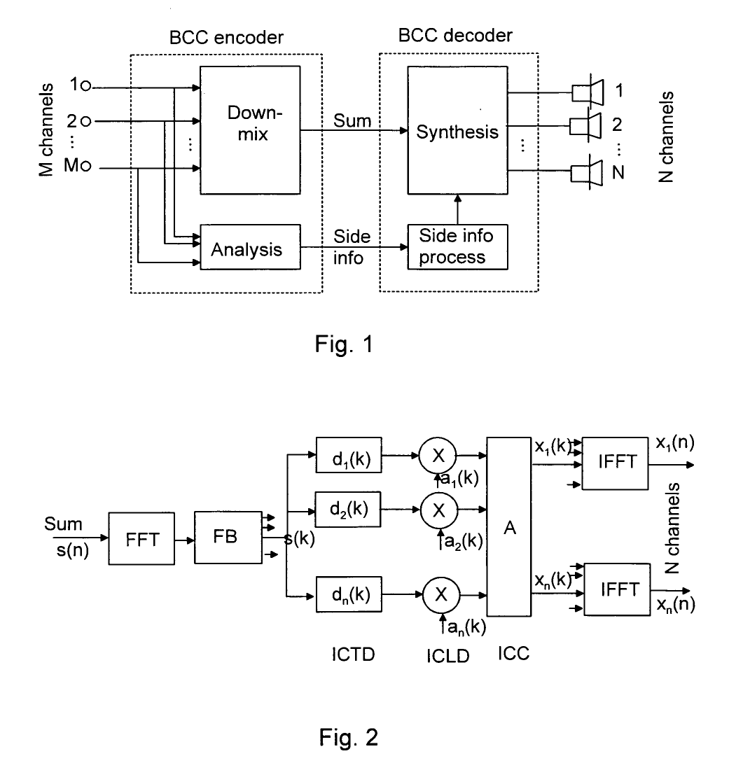

Binaural Cue Coding (BCC) is a general concept for parametric representation of spatial audio, delivering multi-channel output with an arbitrary number of channels from a single audio channel plus some side information. FIG. 1 illustrates this concept. Several (M) input audio channels are combined into a single output (S; “sum”) signal by a downmix process. In parallel, the most salient inter-channel cues describing the multi-channel sound image are extracted from the input channels and coded compactly as BCC side information. Both sum signal and side information are then transmitted to the receiver side, possibly using an appropriate low bitrate audio coding scheme for coding the sum signal. Finally, the BCC decoder generates a multi-channel (N) output signal for loudspeakers from the transmitted sum signal and the spatial cue information by re-synthesizing channel output signals, which carry the relevant inter-channel cues, such as Inter-channel Time Difference (ICTD), Inter-channel Level Difference (ICLD) and Inter-channel Coherence (ICC). Accordingly, the BCC side information, i.e. the inter-channel cues, is chosen in view of optimizing the reconstruction of the multi-channel audio signal particularly for loudspeaker playback.

There are two BCC schemes, namely BCC for Flexible Rendering (type I BCC), which is meant for transmission of a number of separate source signals for the purpose of rendering at the receiver, and BCC for Natural Rendering (type II BCC), which is meant for transmission of a number of audio channels of a stereo or surround signal. BCC for Flexible Rendering takes separate audio source signals (e.g. speech signals, separately recorded instruments, multitrack recording) as input. BCC for Natural Rendering, in turn, takes a “final mix” stereo or multi-channel signal as input (e.g. CD audio, DVD surround). If these processes are carried out through conventional coding techniques, the bitrate scales proportionally or at least nearly proportionally to the number of audio channels, e.g. transmitting the six audio channels of the 5.1. multi-channel system requires a bitrate nearly six times of one audio channel. However, both BCC schemes result in a bitrate, which is only slightly higher than the bitrate required for the transmission of one audio channel, since the BCC side information requires only a very low bitrate (e.g. 2 kb/s).

FIG. 2 shows the general structure of a BCC synthesis scheme. The transmitted mono signal (“sum”) is first windowed in time domain into frames and then mapped to a spectral representation of appropriate subbands by a FFT process (Fast Fourier Transform) and a filterbank FB. In the general case of playback channels the ICLD and ICTD are considered in each subband between pairs of channels, i.e. for each channel relative to a reference channel. The subbands are selected such that a sufficiently high frequency resolution is achieved, e.g. a subband width equal to twice the ERB scale (Equivalent Rectangular Bandwidth) is typically considered suitable. For each output channel to be generated, individual time delays ICTD and level differences ICLD are imposed on the spectral coefficients, followed by a coherence synthesis process which re-introduces the most relevant aspects of coherence and/or correlation (ICC) between the synthesized audio channels. Finally, all synthesized output channels are converted back into a time domain representation by an IFFT process (Inverse FFT), resulting in the multi-channel output. For a more detailed description of the BCC approach, a reference is made to: F. Baumgarte and C. Faller: “Binaural Cue Coding—Part I: Psychoacoustic Fundamentals and Design Principles”; IEEE Transactions on Speech and Audio Processing, Vol. 11, No. 6, November 2003, and to: C. Faller and F. Baumgarte: “Binaural Cue Coding—Part II: Schemes and Applications”, IEEE Transactions on Speech and Audio Processing, Vol. 11, No. 6, November 2003.

The BCC is an example of coding schemes, which provide a suitable platform for implementing the decoding scheme according to the embodiments. The binaural decoder according to an embodiment receives the monophonized signal and the side information as inputs. The idea is to replace each loudspeaker in the original mix with a pair of HRTFs corresponding to the direction of the loudspeaker in relation to the listening position. Each frequency channel of the monophonized signal is fed to each pair of filters implementing the HRTFs in the proportion dictated by a set of gain values, which can be calculated on the basis of the side information. Consequently, the process can be thought of as implementing a set of virtual loudspeakers, corresponding to the original ones, in the binaural audio scene. Accordingly, the invention adds value to the BCC by allowing for, besides multi-channel audio signals for various loudspeaker layouts, also a binaural audio signal to be derived directly from parametrically encoded spatial audio signal without any intermediate BCC synthesis process.

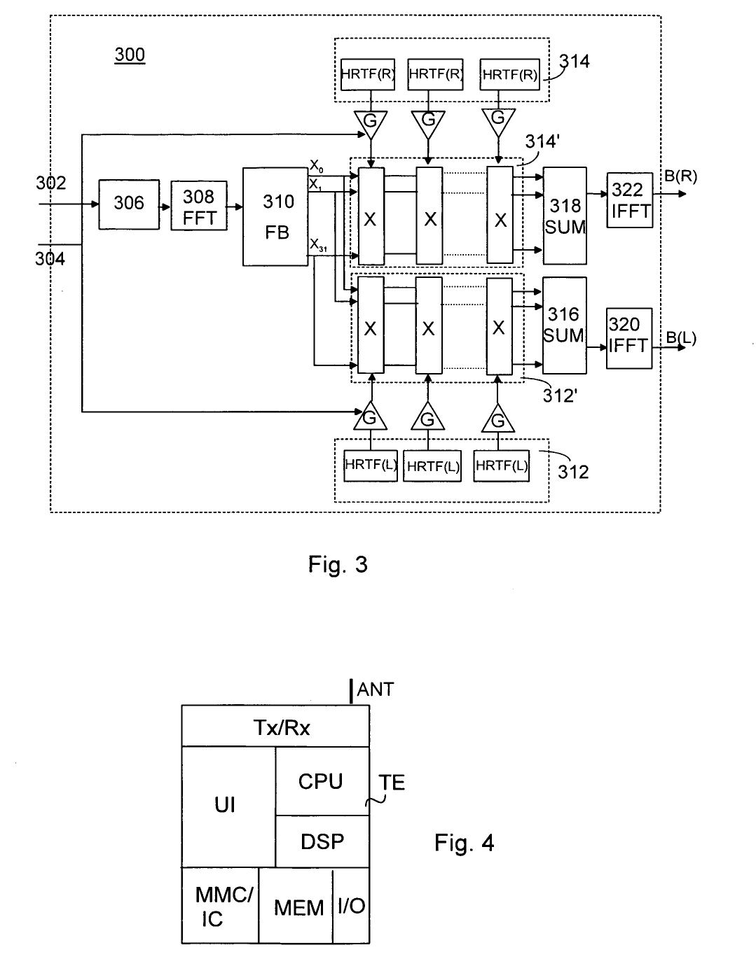

Some embodiments of the invention are illustrated in the following with reference to FIG. 3, which shows a block diagram of the binaural decoder according to an aspect of the invention. The decoder 300 comprises a first input 302 for the monophonized signal and a second input 304 for the side information. The inputs 302, 304 are shown as distinctive inputs for the sake of illustrating the embodiments, but a skilled man appreciates that in practical implementation, the monophonized signal and the side information can be supplied via the same input.

According to an embodiment, the side information does not have to include the same inter-channel cues as in the BCC schemes, i.e. Inter-channel Time Difference (ICTD), Inter-channel Level Difference (ICLD) and Inter-channel Coherence (ICC), but instead only a set of gain estimates defining the distribution of sound pressure among the channels of the original mix at each frequency band suffice. In addition to the gain estimates, the side information preferably includes the number and locations of the loudspeakers of the original mix in relation to the listening position, as well as the employed frame length. According to an embodiment, instead of transmitting the gain estimates as a part of the side information from an encoder, the gain estimates are computed in the decoder from the inter-channel cues of the BCC schemes, e.g. from ICLD.

The decoder 300 further comprises a windowing unit 306 wherein the monophonized signal is first divided into time frames of the employed frame length, and then the frames are appropriately windowed, e.g. sine-windowed. An appropriate frame length should be adjusted such that the frames are long enough for discrete Fourier-transform (DFT) while simultaneously being short enough to manage rapid variations in the signal. Experiments have shown that a suitable frame length is around 50 ms. Accordingly, if the sampling frequency of 44.1 kHz (commonly used in various audio coding schemes) is used, then the frame may comprise, for example, 2048 samples which results in the frame length of 46.4 ms. The windowing is preferably done such that adjacent windows are overlapping by 50% in order to smoothen the transitions caused by spectral modifications (level and delay).

Thereafter, the windowed monophonized signal is transformed into frequency domain in a FFT unit 308. The processing is done in the frequency domain in the objective of efficient computation. A skilled man appreciates that the previous steps of signal processing may be carried out outside the actual decoder 300, i.e. the windowing unit 306 and the FFT unit 308 may be implemented in the apparatus, wherein the decoder is included, and the monophonized signal to be processed is already windowed and transformed into frequency domain, when supplied to the decoder.

For the purpose of efficiently computing the frequency-domained signal, the signal is fed into a filter bank 310, which divides the signal into psycho-acoustically motivated frequency bands. According to an embodiment, the filter bank 310 is designed such that it is arranged to divide the signal into 32 frequency bands complying with the commonly acknowledged Equivalent Rectangular Bandwidth (ERB) scale, resulting in signal components x₀, . . . , x₃₁ on said 32 frequency bands.

The decoder 300 comprises a set of HRTFs 312, 314 as pre-stored information, from which a left-right pair of HRTFs corresponding to each loudspeaker direction is chosen. For the sake of illustration, two sets of HRTFs 312, 314 are shown in FIG. 3, one for the left-side signal and one for the right-side signal, but it is apparent that in practical implementation one set of HRTFs will suffice. For adjusting the chosen left-right pairs of HRTFs to correspond to each loudspeaker channel sound level, the gain values G are preferably estimated. As mentioned above, the gain estimates may be included in the side information received from the encoder, or they may be calculated in the decoder on the basis of the BCC side information. Accordingly, a gain is estimated for each loudspeaker channel as a function of time and frequency, and in order to preserve the gain level of the original mix, the gains for each loudspeaker channel are preferably adjusted such that the sum of the squares of each gain value equals to one. This provides the advantage that, if N is the number of the channels to be virtually generated, then only N−1 gain estimates needs to be transmitted from the encoder, and the missing gain value can be calculated on the basis of the N−1 gain values. A skilled man, however, appreciates that the operation of the invention does not necessitate adjusting the sum of the squares of each gain value to be equal to one, but the decoder can scale the squares of the gain values such that the sum equals to one.

Then each left-right pair of the HRTF filters 312, 314 are adjusted in the proportion dictated by the set of gains G, resulting in adjusted HRTF filters 312′, 314′. Again it is noted that in practice the original HRTF filter magnitudes 312, 314 are merely scaled according to the gain values, but for the sake of illustrating the embodiments, “additional” sets of HRTFs 312′, 314′ are shown in FIG. 3.

For each frequency band, the mono signal components x₀, . . . , x₃₁ are fed to each left-right pair of the adjusted HRTF filters 312′, 314′. The filter outputs for the left-side signal and for the right-side signal are then summed up in summing units 316, 318 for both binaural channels. The summed binaural signals are sine-windowed again, and transformed back into time domain by an inverse FFT process carried out in IFFT units 320, 322. In case the analysis filters don't sum up to one, or their phase response is not linear, a proper synthesis filter bank is then preferably used to avoid distortion in the final binaural signals BR and BL.

According to an embodiment, in order to enhance the externalization, i.e. out-of-the-head localization, of the binaural signal, a moderate room response can be added to the binaural signal. For that purpose, the decoder may comprise a reverberation unit, located preferably between the summing units 316, 318 and the IFFT units 320, 322. The added room response imitates the effect of the room in a loudspeaker listening situation. The reverberation time needed is, however, short enough such that computational complexity is not remarkably increased.

The binaural decoder 300 depicted in FIG. 3 also enables a special case of a stereo downmix decoding, in which the spatial image is narrowed. The operation of the decoder 300 is amended such that each adjustable HRTF filter 312, 314, which in the above embodiments were merely scaled according to the gain values, are replaced by a predetermined gain. Accordingly, the monophonized signal is processed through constant HRTF filters consisting of a single gain multiplied by a set of gain values calculated on the basis of the side information. As a result, the spatial audio is down mixed into a stereo signal. This special case provides the advantage that a stereo signal can be created from the combined signal using the spatial side information without the need to decode the spatial audio, whereby the procedure of stereo decoding is simpler than in conventional BCC synthesis. The structure of the binaural decoder 300 remains otherwise the same as in FIG. 3, only the adjustable HRTF filter 312, 314 are replaced by downmix filters having predetermined gains for the stereo down mix.

If the binaural decoder comprises HRTF filters, for example, for a 5.1 surround audio configuration, then for the special case of the stereo downmix decoding the constant gains for the HRTF filters may be, for example, as defined in Table 1.

TABLE 1
HRTF filters for stereo down mix

| HRTF | Left | Right |
|---|---|---|
| Front left | 1.0 | 0.0 |
| Front right | 0.0 | 1.0 |
| Center | Sqrt (0.5) | Sqrt (0.5) |
| Rear left | Sqrt (0.5) | 0.0 |
| Rear right | 0.0 | Sqrt (0.5) |
| LFE | Sqrt (0.5) | Sqrt (0.5) |

The arrangement according to the invention provides significant advantages. A major advantage is the simplicity and low computational complexity of the decoding process. The decoder is also flexible in the sense that it performs the binaural upmix completely on the basis of the spatial and encoding parameters given by the encoder. Furthermore, equal spatiality regarding the original signal is maintained in the conversion. As for the side information, a set of gain estimates of the original mix suffice. From the point of view of transmitting or storing the audio, the most significant advantage is gained through the improved efficiency when utilizing the compressive intermediate state provided in the parametric audio coding.

A skilled man appreciates that, since the HRTFs are highly individual and averaging is impossible, perfect re-spatialization could only be achieved by measuring the listener's own unique HRTF set. Accordingly, the use of HRTFs inevitably colorizes the signal such that the quality of the processed audio is not equivalent to the original.

However, since measuring each listener's HRTFs is an unrealistic option, the best possible result is achieved, when either a modelled set or a set measured from a dummy head or a person with a head of average size and remarkable symmetry, is used.

As stated earlier, according to an embodiment the gain estimates may be included in the side information received from the encoder. Consequently, an aspect of the invention relates to an encoder for multichannel spatial audio signal that estimates a gain for each loudspeaker channel as a function of frequency and time and includes the gain estimations in the side information to be transmitted along the one (or more) combined channel. The encoder may be, for example, a BCC encoder known as such, which is further arranged to calculate the gain estimates, either in addition to or instead of, the inter-channel cues ICTD, ICLD and ICC describing the multi-channel sound image. Then both the sum signal and the side information, comprising at least the gain estimates, are transmitted to the receiver side, preferably using an appropriate low bitrate audio coding scheme for coding the sum signal.

According to an embodiment, if the gain estimates are calculated in the encoder, the calculation is carried out by comparing the gain level of each individual channel to the cumulated gain level of the combined channel. I.e. if we denote the gain levels by X, the individual channels of the original loudspeaker layout by “m” and samples by “k”, then for each channel the gain estimate is calculated as |Xₘ(k)|/|X_{SUM}(k)|. Accordingly, the gain estimates determine the proportional gain magnitude of each individual channel in comparison to total gain magnitude of all channels.

According to an embodiment, if the gain estimates are calculated in the decoder on the basis of the BCC side information, the calculation may be carried out e.g. on the basis of the values of the Inter-channel Level Difference ICLD. Consequently, if N is the number of the “loudspeakers” to be virtually generated, then N−1 equations, comprising N−1 unknown variables, are first composed on the basis of the ICLD values. Then the sum of the squares of each loudspeaker equation is set equal to 1, whereby the gain estimate of one individual channel can be solved, and on the basis of the solved gain estimate, the rest of the gain estimates can be solved from the N−1 equations.

For example, if the number of the channels to be virtually generated is five (N=5), the N−1 equations may be formed as follows: L2=L1+ICLD1, L3=L1+ICLD2, L4=L1+ICLD3 and L5=L1+ICLD4. Then the sum of their squares is set equal to 1: L1²+(L1+ICLD1)²+(L1+ICLD2)²+(L1+ICLD3)²+(L1+ICLD4)²=1. The value of L1 can then be solved, and on the basis of L1, the rest of the gain level values L2−L5 can be solved.

According to a further embodiment, the basic idea of the invention, i.e. to generate a binaural signal directly from a parametrically encoded audio signal without having to decode it first into a multichannel format, can also be implemented such that instead of using the set of gain estimates and applying them to each frequency subband, only the channel level information (ICLD) part of the side information bit stream is used together with the sum signal(s) to construct the binaural signal.

Accordingly, instead of defining a set of gain estimates in the decoder or including the gain estimates in the BCC side information at the encoder, the channel level information (ICLD) part of the conventional BCC side information of each original channel is appropriately processed as a function of time and frequency in the decoder. The original sum signal(s) is divided into appropriate frequency bins, and gains for the frequency bins are derived from the channel level information. This process enables to further improve the quality of the binaural output signal by introducing smoother changes of the gain values from one frequency band to another.

In this embodiment, the preliminary stages of the process are similar to what is described above: the sum signal(s) (mono or stereo) and the side information are input in the decoder, the sum signal is divided into time frames of the employed frame length, which are then appropriately windowed, e.g. sine-windowed. Again, 50% overlapping sinusoidal windows are used in the analysis and FFT is used to efficiently convert time domain signal to frequency domain. Now, if the length of the analysis window is N samples and the windows are 50% overlapping, we have in frequency domain N/2 frequency bins. In this embodiment, instead of dividing the signal into psycho-acoustically motivated frequency bands, such as subbands according to the ERB scale, the processing is applied to these frequency bins.

As described above, the side information of the BCC encoder provides information on how the sum signal(s) should be scaled to obtain each individual channel. The gain information is generally provided only for restricted time and frequency positions. In the time direction, gain values are given e.g. once in a frame of 2048 samples. For the implementation of the present embodiment, gain values in the middle of every sinusoidal window and for every frequency bin (i.e. N/2 gain values in the middle of every sinusoidal window) are needed. This is achieved efficiently by the means of interpolation. Alternatively, the gain information may be provided in time instances determined in the side information, and the number of time instances within a frame may also be provided in side information. In this alternative implementation, the gain values are interpolated based on the knowledge of time instances and the number of time instances when gain values are updated.

Let us assume that the BCC multichannel encoder provides N_{g} gain values at time instants tₘ, m=0, 1, 2, . . . . In relation to the current time instant t_{w} (the center of current sinusoidal window), the next and previous gain value sets provided by the BCC multichannel encoder are searched, let them be noted by tₚᵣₑᵥ and tₙₑₓₜ. Using for example linear interpolation, N_{g} gain values are interpolated to the time instant t_{w} such that the distances from t_{w} to tₚᵣₑᵥ and tₙₑₓₜ are used in the interpolation as scaling factors. According to another embodiment, the gain value (tₚᵣₑᵥ or tₙₑₓₜ), which is closer to the time instant t_{w}, is simply selected, which provides a more straightforward solution to determine a well-approximated gain value.

After a set of N_{g} gain values for the current time instant have been determined, they need to be interpolated in the frequency direction to obtain an individual gain value for every N/2 frequency bins. Simple linear interpolation can be used to complete this task, however for example sinc-interpolation can be used as well. Generally the N_{g} gain values are given with higher resolution at low frequencies (the resolution may follow e.g. the ERB scale), which has to be considered in the interpolation. The interpolation can be done in linear or in logarithmic domain. The total number of the interpolated gain sets equals to the number of output channels in the multichannel decoder multiplied by the number of sum signals.

Furthermore, the HRTFs of the original speaker directions are needed to construct the binaural signal. Also the HRTFs are converted into the frequency domain. To make the frequency domain processing straightforward, same frame length (N samples) is used in the conversion as what is used for converting time domain sum signal(s) to frequency domain (to N/2 frequency bins).

Let Y₁(n) and Y₂(n) be the frequency domain representation of the binaural left and right signals, respectively. In the case of one sum signal (i.e. a monophonized sum signal Xₛᵤₘ₁(n)), the binaural output is constructed as follows:

$${Y}_{1} ( n ) = {X}_{sum 1} ( n ) {\sum }_{c = 1}^{C} ( {H}_{1}^{c} ( n ) {g}_{1}^{c} ( n ) )$$

$${Y}_{2} ( n ) = {X}_{sum 1} ( n ) {\sum }_{c = 1}^{C} ( {H}_{2}^{c} ( n ) {g}_{1}^{c} ( n ) ) ,$$

where 0≦n<N/2. C is the total number of the channels in the BCC multichannel encoder (e.g. a 5.1 audio signal comprises 6 channels), and g₁^{c}(n) is the interpolated gain value for the mono sum signal to construct channel c at current time instant t_{w}. H₁^{c}(n) and H₂^{c}(n) are the DFT domain representations of HRTFs for left and right ears for multichannel encoder output channel c, i.e. the direction of each original channel has to be known.

When there are two sum signals (stereo sum signal) provided by the BCC multichannel encoder, both sum signals (Xₛᵤₘ₁(n) and Xₛᵤₘ₂(n)) effect on both binaural outputs as follows:

$${Y}_{1} ( n ) = {X}_{sum 1} ( n ) {\sum }_{c = 1}^{C} ( {H}_{1}^{c} ( n ) {g}_{1}^{c} ( n ) ) + {X}_{sum 2} ( n ) {\sum }_{c = 1}^{C} ( {H}_{1}^{c} ( n ) {g}_{2}^{c} ( n ) )$$

$${Y}_{2} ( n ) = {X}_{sum 1} ( n ) {\sum }_{c = 1}^{C} ( {H}_{2}^{c} ( n ) {g}_{1}^{c} ( n ) ) + {X}_{sum 2} ( n ) {\sum }_{c = 1}^{C} ( {H}_{2}^{c} ( n ) {g}_{2}^{c} ( n ) )$$

where 0≦n<N/2. Now g₁^{c}(n) and g₂^{c}(n) represent the gains used for left and right sum signals in the multichannel encoder to construct output channel c as a sum of them.

Again, the late stages of the process are similar to what is described above: the Y₁(n) and Y₂(n) are transformed back to time domain with IFFT process, the signals are sine-windowed once more, and overlapping windows are added together.

The main advantage of the above-described embodiment is that the gains do not change rapidly from one frequency bin to another, which may happen in a case when ERB (or other) subbands are used. Thereby, the quality of the binaural output signal is generally better. Furthermore, by using summed-up DFT domain representations of HRTFs for left and right ears (H₁^{c}(n) and H₂^{c}(n)) instead of particular left-right pairs of HRTFs for each channel of the multichannel audio, the filtering can be significantly simplified.

In the above-described embodiment, the binaural signal was constructed in the DFT domain and the division of signal into subbands according to the ERB scale with the filter bank can be left out. Even though the implementation advantageously does not necessitate any filter bank, a skilled man appreciates that also other related transformation than DFT or suitable filter bank structures with high enough frequency resolution can be used as well. In those cases the above construction equations of Y₁(n) and Y₂(n) have to be modified such that the HRTF filtering is performed based on the properties set by the transformation or the filter bank in question.

Accordingly, if for example a QMF filterbank is applied, then the frequency resolution is defined by the QMF subbands. If the set of N_{g} gain vales is less than the number of QMF subbands, the gain values are interpolated to obtain individual gain for each subband. For example, 28 gain values corresponding to 28 frequency bands for a given time instance available in side information can be mapped to 105 QMF subbands by non-linear or linear interpolation to avoid sudden variations in adjacent narrow subbands. Thereafter, the above-described equations for the frequency domain representation of the binaural left and right signals (Y₁(n), Y₂(n)) apply as well, with the exception that the H₁^{c}(n) and H₂^{c}(n) are HRTF filters in QMF domain in matrix format and Xₛᵤₘ₁(n) a block of monophonized signal. In case of a stereo sum signal, the HRTF filters are in convolution matrix form and Xₛᵤₘ₁(n) and Xₛᵤₘ₂(n) are blocks of the two sum signals, respectively. An example of the actual filtering implementation in QMF domain is described in the document IEEE 0-7803-5041-3/99, Lanciani C. A. et al.: “Subband domain filtering of MPEG audio signals”.

For the sake of simplicity, most of the previous examples are described such that the input channels (M) are downmixed in the encoder to form a single combined (e.g. mono) channel. However, the embodiments are equally applicable in alternative implementations, wherein the multiple input channels (M) are downmixed to form two or more separate combined channels (S), depending on the particular audio processing application. If the downmixing generates multiple combined channels, the combined channel data can be transmitted using conventional audio transmission techniques. For example, if two combined channels are generated, conventional stereo transmission techniques may be employed. In this case, a BCC decoder can extract and use the BCC codes to synthesize a binaural signal from the two combined channels, which is illustrated in connection with the last embodiment above.

According to an embodiment, the number (N) of the virtually generated “loudspeakers” in the synthesized binaural signal may be different than (greater than or less than) the number of input channels (M), depending on the particular application. For example, the input audio could correspond to 7.1 surround sound and the binaural output audio could be synthesized to correspond to 5.1 surround sound, or vice versa.

The above embodiments may be generalized such that the embodiments of the invention allow for converting M input audio channels into S combined audio channels and one or more corresponding sets of side information, where M>S, and for generating N output audio channels from the S combined audio channels and the corresponding sets of side information, where N>S, and N may be equal to or different from M.

Since the bitrate required for the transmission of one combined channel and the necessary side information is very low, the invention is especially well applicable in systems, wherein the available bandwidth is a scarce resource, such as in wireless communication systems. Accordingly, the embodiments are especially applicable in mobile terminals or in other portable device typically lacking high-quality loudspeakers, wherein the features of multi-channel surround sound can be introduced through headphones listening the binaural audio signal according to the embodiments. A further field of viable applications include teleconferencing services, wherein the participants of the teleconference can be easily distinguished by giving the listeners the impression that the conference call participants are at different locations in the conference room.

FIG. 4 illustrates a simplified structure of a data processing device (TE), wherein the binaural decoding system according to the invention can be implemented. The data processing device (TE) can be, for example, a mobile terminal, a MP3 player, a PDA device or a personal computer (PC). The data processing unit (TE) comprises I/O means (I/O), a central processing unit (CPU) and memory (MEM). The memory (MEM) comprises a read-only memory ROM portion and a rewriteable portion, such as a random access memory RAM and FLASH memory. The information used to communicate with different external parties, e.g. a CD-ROM, other devices and the user, is transmitted through the I/O means (I/O) to/from the central processing unit (CPU). If the data processing device is implemented as a mobile station, it typically includes a transceiver Tx/Rx, which communicates with the wireless network, typically with a base transceiver station (BTS) through an antenna. User Interface (UI) equipment typically includes a display, a keypad, a microphone and connecting means for headphones. The data processing device may further comprise connecting means MMC, such as a standard form slot, for various hardware modules or as integrated circuits IC, which may provide various applications to be run in the data processing device.

Accordingly, the binaural decoding system according to the invention may be executed in a central processing unit CPU or in a dedicated digital signal processor DSP (a parametric code processor) of the data processing device, whereby the data processing device receives a parametrically encoded audio signal comprising at least one combined signal of a plurality of audio channels and one or more corresponding sets of side information describing a multi-channel sound image. The parametrically encoded audio signal may be received from memory means, e.g. a CD-ROM, or from a wireless network via the antenna and the transceiver Tx/Rx. The data processing device further comprises a suitable filter bank and a predetermined set of head-related transfer function filters, whereby the data processing device transforms the combined signal into frequency domain and applies a suitable left-right pairs of head-related transfer function filters to the combined signal in proportion determined by the corresponding set of side information to synthesize a binaural audio signal, which is then reproduced via the headphones.

Likewise, the encoding system according to the invention may as well be executed in a central processing unit CPU or in a dedicated digital signal processor DSP of the data processing device, whereby the data processing device generates a parametrically encoded audio signal comprising at least one combined signal of a plurality of audio channels and one or more corresponding sets of side information including gain estimates for the channel signals of the multi-channel audio.

The functionalities of the invention may be implemented in a terminal device, such as a mobile station, also as a computer program which, when executed in a central processing unit CPU or in a dedicated digital signal processor DSP, affects the terminal device to implement procedures of the invention. Functions of the computer program SW may be distributed to several separate program components communicating with one another. The computer software may be stored into any memory means, such as the hard disk of a PC or a CD-ROM disc, from where it can be loaded into the memory of mobile terminal. The computer software can also be loaded through a network, for instance using a TCP/IP protocol stack.

It is also possible to use hardware solutions or a combination of hardware and software solutions to implement the inventive means. Accordingly, the above computer program product can be at least partly implemented as a hardware solution, for example as ASIC or FPGA circuits, in a hardware module comprising connecting means for connecting the module to an electronic device, or as one or more integrated circuits IC, the hardware module or the ICs further including various means for performing said program code tasks, said means being implemented as hardware and/or software.

It will be evident to anyone of skill in the art that the present invention is not limited solely to the above-presented embodiments, but it can be modified within the scope of the appended claims.

1. A method for synthesizing a binaural audio signal, the method comprising:
inputting a parametrically encoded audio signal comprising at least one combined signal of a plurality of audio channels and one or more corresponding sets of side information describing a multi-channel sound image; and
applying a predetermined set of head-related transfer function filters to the at least one combined signal in proportion determined by said corresponding set of side information to synthesize a binaural audio signal.

2. The method according to claim 1, further comprising:
applying, from the predetermined set of head-related transfer function filters, a left-right pair of head-related transfer function filters corresponding to each loudspeaker direction of the original multi-channel audio.

3. The method according to claim 1, wherein
said set of side information comprises a set of gain estimates for the channel signals of the multi-channel audio describing the original sound image.

4. The method according to claim 3, wherein
said set of side information further comprises the number and locations of loudspeakers of the original multi-channel sound image in relation to a listening position, and an employed frame length.

5. The method according to claim 1, wherein
said set of side information comprises inter-channel cues used in Binaural Cue Coding (BCC) scheme, such as Inter-channel Time Difference (ICTD), Inter-channel Level Difference (ICLD) and Inter-channel Coherence (ICC), the method further comprising:
calculating a set of gain estimates of the original multi-channel audio based on at least one of said inter-channel cues of the BCC scheme.

6. The method according to claim 3, further comprising:
determining the set of the gain estimates of the original multi-channel audio as a function of time and frequency; and
adjusting the gains for each loudspeaker channel such that the sum of the squares of each gain value equals to one.

7. The method according to claim 1, further comprising:
dividing the at least one combined signal into time frames of an employed frame length, which frames are then windowed; and
transforming the at least one combined signal into frequency domain prior to applying the head-related transfer function filters.

8. The method according to claim 7, further comprising:
dividing the at least one combined signal in frequency domain into a plurality of psycho-acoustically motivated frequency bands prior to applying the head-related transfer function filters.

9. The method according to claim 8, further comprising:
dividing the at least one combined signal in frequency domain into 32 frequency bands complying with the Equivalent Rectangular Bandwidth (ERB) scale.

10. The method according to claim 8, further comprising:
summing up outputs of the head-related transfer function filters for each of said frequency band for a left-side signal and a right-side signal separately; and
transforming the summed left-side signal and the summed right-side signal into time domain to create a left-side component and a right-side component of a binaural audio signal.

11. The method according to claim 1, further comprising:
dividing the at least one combined signal into a plurality of frequency bins in frequency domain; and
determining gain values for each frequency bin from said set of side information prior to applying the head-related transfer function filters.

12. The method according to claim 11, wherein
said gain values are determined by interpolating each gain value corresponding to a particular frequency bin from next and previous gain values provided by said set of side information.

13. The method according to claim 11, wherein
said gain values are determined by selecting the closest gain value provided by said set of side information.

14. The method according to claim 11, wherein the step of dividing the at least one combined signal into a plurality of frequency bins in frequency domain further comprises:
dividing the at least one combined signal into time frames comprising a predetermined number of samples, which frames are then windowed;
setting adjacent windows overlapping to each other by substantially 50%; and
transforming the at least one combined signal into frequency domain to create the plurality of frequency bins.

15. The method according to claim 11, wherein the step of determining gain values for each frequency bin further comprises:
determining gain values for each channel signal of the multi-channel audio describing the original sound image; and
interpolating a single gain value for each frequency bin from said gain values of each channel signal.

16. The method according to claim 11, further comprising:
determining a frequency domain representation of the binaural signal for each frequency bin by multiplying said at least one combined signal with said single gain value and a predetermined head-related transfer function filter.

17. The method according to claim 16, wherein the frequency domain representations of the binaural signals for each frequency bin are determined from a monophonized sum signal Xₛᵤₘ₁(n) according to:
$${Y}_{1} ( n ) = {X}_{sum 1} ( n ) {\sum }_{c = 1}^{C} ( {H}_{1}^{c} ( n ) {g}_{1}^{c} ( n ) )$$
$${Y}_{2} ( n ) = {X}_{sum 1} ( n ) {\sum }_{c = 1}^{C} ( {H}_{2}^{c} ( n ) {g}_{1}^{c} ( n ) )$$
wherein Y₁(n) and Y₂(n) are the frequency domain representation of the binaural left and right signals, c is the number of the encoder channels, g₁^{c}(n) is the interpolated gain value for the mono sum signal to construct channel c at a particular time instant t_{w}, and H₁^{c}(n) and H₂^{c}(n) are DFT domain representations of the head-related transfer function filters for left and right ears for encoder output channel c.

18. The method according to claim 16, wherein the frequency domain representations of the binaural signals for each frequency bin are determined from stereo sum signals Xₛᵤₘ₁(n) and Xₛᵤₘ₂(n) according to:
$${Y}_{1} ( n ) = {X}_{sum 1} ( n ) {\sum }_{c = 1}^{C} ( {H}_{1}^{c} ( n ) {g}_{1}^{c} ( n ) ) + {X}_{sum 2} ( n ) {\sum }_{c = 1}^{C} ( {H}_{1}^{c} ( n ) {g}_{2}^{c} ( n ) )$$
$${Y}_{2} ( n ) = {X}_{sum 1} ( n ) {\sum }_{c = 1}^{C} ( {H}_{2}^{c} ( n ) {g}_{1}^{c} ( n ) ) + {X}_{sum 2} ( n ) {\sum }_{c = 1}^{C} ( {H}_{2}^{c} ( n ) {g}_{2}^{c} ( n ) )$$
wherein Y₁(n) and Y₂(n) are the frequency domain representation of the binaural left and right signals, c is the number of the encoder channels, g₁^{c}(n) is the interpolated gain value for the mono sum signal to construct channel c at a particular time instant t_{w}, and H₁^{c}(n) and H₂^{c}(n) are DFT domain representations of the head-related transfer function filters for left and right ears for encoder output channel c.

19. The method according to claim 7, further comprising:
dividing the at least one combined signal into a plurality of frequency subbands; and
determining gain values for each frequency subband from said set of side information prior to applying the head-related transfer function filters.

20. The method according to claim 19, wherein said gain values are determined by interpolating each gain value corresponding to a particular frequency subband from gain values of the adjacent frequency subbands provided by said set of side information.

21. A method for synthesizing a stereo audio signal, the method comprising:
inputting a parametrically encoded audio signal comprising at least one combined signal of a plurality of audio channels and one or more corresponding sets of side information describing a multi-channel sound image; and
applying a set of downmix filters having predetermined gain values to the at least one combined signal in proportion determined by said corresponding set of side information to synthesize a stereo audio signal.

22. A parametric audio decoder, comprising:
a parametric code processor for processing a parametrically encoded audio signal comprising at least one combined signal of a plurality of audio channels and one or more corresponding sets of side information describing a multi-channel sound image; and
a synthesizer for applying a predetermined set of head-related transfer function filters to the at least one combined signal in proportion determined by said corresponding set of side information to synthesize a binaural audio signal.

23. The decoder according to claim 22, wherein
said synthesizer is arranged to apply, from the predetermined set of head-related transfer function filters, a left-right pair of head-related transfer function filters corresponding to each loudspeaker direction of the original multi-channel audio.

24. The decoder according to claim 22, wherein
said set of side information comprises a set of gain estimates for the channel signals of the multi-channel audio describing the original sound image.

25. The decoder according to claim 22, wherein
said set of side information comprises inter-channel cues used in Binaural Cue Coding (BCC) scheme, such as Inter-channel Time Difference (ICTD), Inter-channel Level Difference (ICLD) and Inter-channel Coherence (ICC), the decoder being arranged to
calculate a set of gain estimates of the original multi-channel audio based on at least one of said inter-channel cues of the BCC scheme.

26. The decoder according to claim 22, further comprising:
means for dividing the at least one combined signal into time frames of an employed frame length,
means for windowing the frames; and
means for transforming the at least one combined signal into frequency domain prior to applying the head-related transfer function filters.

27. The decoder according to claim 26, further comprising:
means for dividing the at least one combined signal in frequency domain into a plurality of psycho-acoustically motivated frequency bands prior to applying the head-related transfer function filters.

28. The decoder according to claim 27, wherein:
said means for dividing the at least one combined signal in frequency domain comprises a filter bank arranged to divide the at least one combined signal into 32 frequency bands complying with the Equivalent Rectangular Bandwidth (ERB) scale.

29. The decoder according to claim 27, further comprising:
a summing unit for summing up outputs of the head-related transfer function filters for each of said frequency band for a left-side signal and a right-side signal separately; and
a transforming unit for transforming the summed left-side signal and the summed right-side signal into time domain to create a left-side component and a right-side component of a binaural audio signal.

30. The decoder according to claim 22, further comprising:
means for dividing the at least one combined signal into a plurality of frequency bins in frequency domain; and
means for determining gain values for each frequency bin from said set of side information prior to applying the head-related transfer function filters.

31. The decoder according to claim 30, wherein
said gain values are determined by interpolating each gain value corresponding to a particular frequency bin from next and previous gain values provided by said set of side information.

32. The decoder according to claim 30, wherein
said gain values are determined by selecting the closest gain value provided by said set of side information.

33. The decoder according to claim 30, wherein said means for determining gain values for each frequency bin are arranged to:
determine gain values for each channel signal of the multi-channel audio describing the original sound image; and
interpolate a single gain value for each frequency bin from said gain values of each channel signal.

34. The decoder according to claim 30, wherein said decoder is arranged to:
determine a frequency domain representation of the binaural signal for each frequency bin by multiplying said at least one combined signal with said single gain value and a predetermined head-related transfer function filter.

35. A parametric audio decoder, comprising:
a parametric code processor for processing a parametrically encoded audio signal comprising at least one combined signal of a plurality of audio channels and one or more corresponding sets of side information describing a multi-channel sound image; and
a synthesizer for applying a set of downmix filters having predetermined gain values to the at least one combined signal in proportion determined by said corresponding set of side information to synthesize a stereo audio signal.

36. A computer program product, stored on a computer readable medium and executable in a data processing device, for processing a parametrically encoded audio signal comprising at least one combined signal of a plurality of audio channels and one or more corresponding sets of side information describing a multi-channel sound image, the computer program product comprising:
a computer program code section for controlling transforming of the at least one combined signal into frequency domain; and
a computer program code section for applying a predetermined set of head-related transfer function filters to the at least one combined signal in proportion determined by said corresponding set of side information to synthesize a binaural audio signal.

37. An apparatus for synthesizing a binaural audio signal, the apparatus comprising:
means for inputting a parametrically encoded audio signal comprising at least one combined signal of a plurality of audio channels and one or more corresponding sets of side information describing a multi-channel sound image;
means for applying a predetermined set of head-related transfer function filters to the at least one combined signal in proportion determined by said corresponding set of side information to synthesize a binaural audio signal; and
means for supplying the binaural audio signal in audio reproduction means.

38. The apparatus according to claim 37, said apparatus being a mobile terminal, a PDA device or a personal computer.

39. A method for generating a parametrically encoded audio signal, the method comprising:
inputting a multi-channel audio signal comprising a plurality of audio channels;
generating at least one combined signal of the plurality of audio channels; and
generating one or more corresponding sets of side information including gain estimates for the plurality of audio channels.

40. The method according to claim 39, further comprising:
calculating the gain estimates by comparing the gain level of each individual channel to the cumulated gain level of the combined signal.

41. The method according to claim 39, wherein
said set of side information further comprises the number and locations of loudspeakers of an original multi-channel sound image in relation to a listening position, and an employed frame length.

42. The method according to claim 39, wherein
said set of side information further comprises inter-channel cues used in Binaural Cue Coding (BCC) scheme, such as Inter-channel Time Difference (ICTD), Inter-channel Level Difference (ICLD) and Inter-channel Coherence (ICC).

43. The method according to claim 39, further comprising:
determining the set of the gain estimates of the original multi-channel audio as a function of time and frequency; and
adjusting the gains for each loudspeaker channel such that the sum of the squares of each gain value equals to one.

44. A parametric audio encoder for generating a parametrically encoded audio signal, the encoder comprising:
means for inputting a multi-channel audio signal comprising a plurality of audio channels;
means for generating at least one combined signal of the plurality of audio channels; and
means for generating one or more corresponding sets of side information including gain estimates for the plurality of audio channels.

45. The encoder according to claim 44, further comprising:
means for calculating the gain estimates by comparing the gain level of each individual channel to the cumulated gain level of the combined signal.

46. A computer program product, stored on a computer readable medium and executable in a data processing device, for generating a parametrically encoded audio signal, the computer program product comprising:
a computer program code section for inputting a multi-channel audio signal comprising a plurality of audio channels;
a computer program code section for generating at least one combined signal of the plurality of audio channels; and
a computer program code section for generating one or more corresponding sets of side information including gain estimates for the plurality of audio channels.
